(19) United States
(12) Patent Application Publication
(10) Pub. No.: US 2014/0026570 A1
(43) Pub. Date: Jan. 30, 2014

(54) Solar thermodynamic machine power generation technology

(71) Applicants: Haibiao Wang, Yokohama (JP); Jyoji Muto, Yokohama (JP); Jimmy Wang, Yokohama (JP); Fangtai Ma, Yokohama (JP)

(72) Inventors: Haibiao Wang, Yokohama (JP); Jyoji Muto, Yokohama (JP); Jimmy Wang, Yokohama (JP); Fangtai Ma, Yokohama (JP)

(21) Appl. No.: 13/557,220

(22) Filed: Jul. 25, 2012

(51) Int. Cl. F03G 6/00

(52) U.S. Cl. 60/641.8

(57) ABSTRACT

A solar thermodynamic machine power generation method can use the radiant energy of the solar concentrator, and directly convert the internal energy of the working medium molecule with cyclic phase transformation at low boiling point into electric energy for achieving the fuel-free large-scale electric power production. It has the characteristics of long-term continuous operation, green environmental protection, safety and reliability and low cost, and has a great application and social economic value. It makes use of the internal energy exchanging of the working medium molecule. It working process is thermal cycling balance. The present invention can be long-term continuously operated without the external power and does not consume any fuel and water. It is especially suitably applied to the solar tower-type and other light-gathering and thermal storage power generation systems.

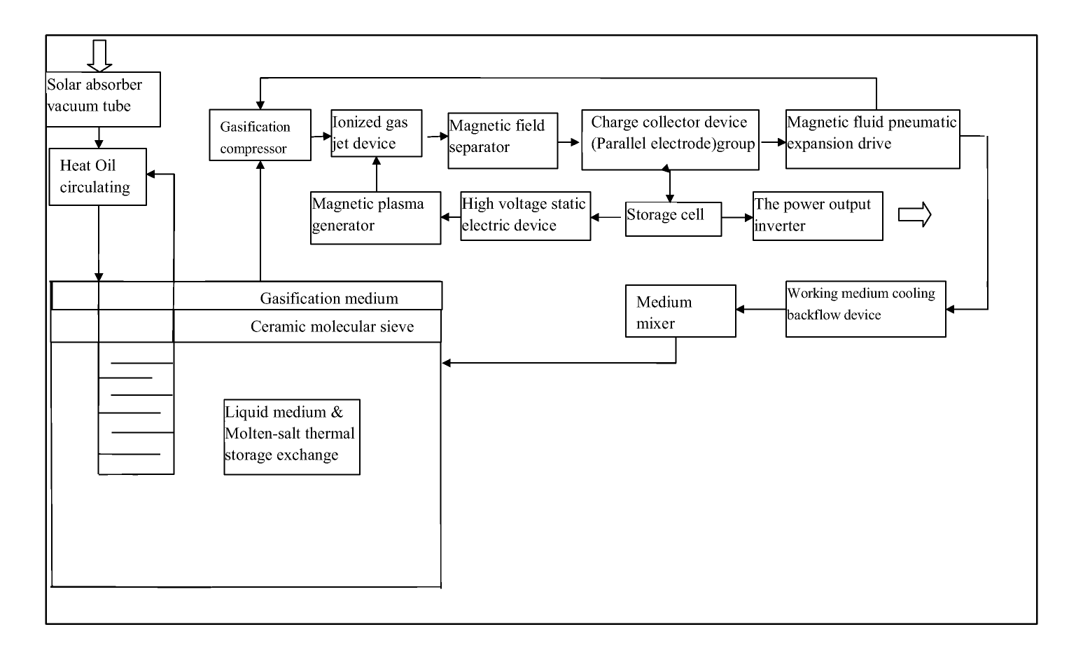

### BACKGROUND OF THE PRESENT INVENTION

1. Field of Invention

The present invention relates to a solar thermodynamic machine power generation technology.

2. Description of Related Arts

In the current heat power generation method, heat energy is converted into mechanical energy by the steam turbine, and then into electrical energy. Therefore, the energy transmission links are more, the energy efficiency is low, and a lot of fuels are consumed. The present invention makes use of the direct conversion of the internal molecular energy. Its working process is thermal cycling balance. It can be long-term continuously operated without the external power and does not consume any fuel and water. It is especially suitably applied to the solar tower-type and other light-gathering and thermal storage power generation systems.

### SUMMARY OF THE PRESENT INVENTION

An object of the present invention is to provide a solar thermodynamic machine power generation method, which is capable of by using accumulation solar radiation heat energy, making the low boiling point medium take place to phase change cycle, separating charged particles about power generation device through strong magnetic field effect, making the medium molecular internal energy converted directly into electrical energy, thus producing the electric power without fuel.

Another object of the present invention is to provide a solar thermodynamic machine power generation method, in which through the glass vacuum tubes absorbing solar radiation, the oily media in the closed and adiabatic heat storage pool enter the thermal energy cycle, and the special ceramic molecular sieve is used to isolate liquid and gas medium to form no-pipe heat exchanger, thus improving the thermal efficiency, also acquiring higher gasification pressure, and producing stronger thrust.

Another object of the present invention is to provide a solar thermodynamic machine power generation method, in which the cooling medium must influx at the middle position of the heat storage pool, which is located above the molten salt layer, and under in the ceramic molecular sieve layer, so the continuous gas heat cycle can be realized. And use media expansion force to feedback, to keep thermal cycle balance of the working system.

Another object of the present invention is to provide a solar thermodynamic machine power generation method, which by the ionization medium, makes the gas state medium form the magnetic plasma molecule, through the strong magnetic field effect, separates the charged particles, uses the parallel capacitor metal plate to gather the charge, that output give liquid battery, storage power generation.

Another object of the present invention is to provide a solar thermodynamic machine power generation method, which belongs to one of the renewable energy technology, has green environmental protection, low cost and obtained social widely attention.

Accordingly, in order to accomplish the above objects, the present invention provides a solar thermodynamic machine power generation method, comprising:
(A) absorbing a solar radiation and bringing a heat circulation to a closed adiabatic heat storage pool by a vacuum oil guiding tube;
(B) making gasification medium molecules with higher vapor pressure via a heat exchanger using a ceramic molecular sieve as a phase-change medium, for producing a compression power;
(C) generating a hot molecules current to the heat storage pool;
(D) cooling and flowing back the working medium to a middle space of the heat storage pool, provided above a molten salt layer and below the ceramic molecular sieve, for repeatedly cycling gas and heat; and
(E) keeping a thermal cycling balance by using the magnetic fluid medium expansion force to feedback in the system.

These and other objectives, features, and advantages of the present invention will become apparent from the following detailed description, the accompanying drawings, and the appended claims.

### BRIEF DESCRIPTION OF THE DRAWINGS

The drawing is a flow chart of a solar thermodynamic machine power generation method according to a preferred embodiment of the present invention.

### DETAILED DESCRIPTION OF THE PREFERRED EMBODIMENT

The present invention is further explained in detail with the accompanying drawing.

The solar thermodynamic machine comprises a solar light-gathering and thermal storage system, a working medium vacuum heat exchanging system, a working medium cooling backflow system, a gasification compression injection system, an electrostatic high-voltage ionization system, a strong magnetic field system, a parallel capacitance plate electronic collection system, a plasma MHD (ionized medium) expansion driving system, and an external battery variable frequency power system.

Referring to the drawing, a solar thermodynamic machine power generation method according to a preferred embodiment of the present invention is illustrated. When the magnetic fluid gasification medium passes through the compressed spray chamber, the gas is ionized by the high-pressure discharge slot for forming the plasma beam. The ionized medium is compressed, and then periodically injected into a vertical magnetic field and parallel symmetrical capacitance plate device. When the plasma magnetic fluid passes through the vertically strong magnetic field, the moving charges are collected by multiple groups of symmetric parallel capacitance metal plates in the vertical magnetic field for generating the potential difference, thereby achieving the power generation.

The working principle of the solar thermodynamic machine power generation method of the present invention is described as follows. When the magnetic fluid plasma is formed, a lot of positive and negative charged particles are contained. Due to the Lorentz force existing among the molecules, the charged particles are off balance under the effect of the vertically strong magnetic field repulsion, the trajectories of the different charged particles are migrated, thus separating the positive and negative charges. Therefore, a lot of charges are gathered at two sides of the parallel capacitance plate for forming the potential difference.

The solar thermodynamic machine power generation device of the present invention can continuously provide sufficient magnetic fluid plasma to pass through the strong magnetic field by the solar heat storage exchanging system, and connect the electronic collecting plate in the strong magnetic field to the external load battery for producing and outputting the continuous current.

According to the drawing, the solar thermodynamic machine power generation method comprises the steps of:
(A) absorbing a solar radiation and bringing a heat circulation to a closed adiabatic heat storage pool by a vacuum oil guiding tube;
(B) making gasification medium molecules with higher vapor pressure via a heat exchanger using a ceramic molecular sieve as a phase-change medium, for producing a compression power;
(C) generating a hot molecules current to the heat storage pool;
(D) cooling and flowing back the working medium to a middle space of the heat storage pool, provided above a molten salt layer and below the ceramic molecular sieve, for repeatedly cycling gas and heat; and
(E) keeping a thermal cycling balance by using the magnetic fluid medium expansion force to feedback in the system.

The molten salt layer of the solar heat storage pool is mixed with easily ionized potassium and sodium constituent and rare earth nanomaterials.

The step (C) comprises the steps of:
(C1) ionizing gas via a high-pressure discharge slot when magnetic fluid gasification medium passes through a compressed spray chamber for forming a plasma beam;
(C2) periodically injecting the compressed ionized medium into a vertical magnetic field and parallel symmetrical capacitance plate device; and
(C3) collecting moving charges by multiple groups of symmetric parallel capacitance metal plates in the vertical magnetic field when the plasma magnetic fluid passes through the vertically strong magnetic field for generating a potential difference, thereby achieving a power generation.

The gaseous molecules are compressed by the generated steam, which can accelerate the jet velocity of the charged fluid. Furthermore, it is worth mentioning that the plasma is formed by low-temperature ionization method instead of using high temperature combustion method for the formation of plasma, which is essentially different from the previous method of generating electricity.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A solar thermodynamic machine power generation method, comprising:
(A) absorbing a solar radiation and bringing a heat circulation to a closed adiabatic heat storage pool by a vacuum oil guiding tube;
(B) making gasification medium molecules with higher vapor pressure via a heat exchanger using a ceramic molecular sieve as a phase-change medium, for producing a compression power;
(C) generating a hot molecules current to the heat storage pool;
(D) cooling and flowing back the working medium to a middle space of the heat storage pool for repeatedly cycling gas and heat; and
(E) keeping a thermal cycling balance by using the magnetic fluid medium expansion force to feedback in the system.

2. The solar thermodynamic machine power generation method, as recited in claim 1, wherein step (C) comprises:
(C1) ionizing gas when magnetic fluid gasification medium passes through a compressed spray chamber for forming a plasma beam;
(C2) periodically injecting the compressed ionized medium into a vertical magnetic field and parallel symmetrical capacitance plate device; and
(C3) collecting moving charges by multiple groups of symmetric parallel capacitance metal plates in the vertical magnetic field when the plasma magnetic fluid passes through the vertically strong magnetic field for generating a potential difference, thereby achieving a power generation.

3. The solar thermodynamic machine power generation method, as recited in claim 1, wherein in step (D), the middle space of the heat storage pool is provided above a molten salt layer and below the ceramic molecular sieve.

4. The solar thermodynamic machine power generation method, as recited in claim 2, wherein in step (D), the middle space of the heat storage pool is provided above a molten salt layer and below the ceramic molecular sieve.

5. The solar thermodynamic machine power generation method, as recited in claim 1, wherein in step (C1), the gas is ionized via a high-pressure discharge slot.

6. The solar thermodynamic machine power generation method, as recited in claim 2, wherein in step (C1), the gas is ionized via a high-pressure discharge slot.

7. The solar thermodynamic machine power generation method, as recited in claim 3, wherein in step (C1), the gas is ionized via a high-pressure discharge slot.

8. The solar thermodynamic machine power generation method, as recited in claim 4, wherein in step (C1), the gas is ionized via a high-pressure discharge slot.

9. The solar thermodynamic machine power generation method, as recited in claim 1, wherein in step (B), the ceramic molecular sieve isolates the liquid working medium from the energy-storage molten salt, so that a phase of the liquid working medium at low temperature is quickly changed, and the medium molecules are gasified by the heat exchanger for forming the pneumatic source.

10. The solar thermodynamic machine power generation method, as recited in claim 2, wherein in step (B), the ceramic molecular sieve isolates the liquid working medium from the energy-storage molten salt, so that a phase of the liquid working medium at low temperature is quickly changed, and the medium molecules are gasified by the heat exchanger for forming the pneumatic source.

11. The solar thermodynamic machine power generation method, as recited in claim 3, wherein in step (B), the ceramic molecular sieve isolates the liquid working medium from the energy-storage molten salt, so that a phase of the liquid working medium at low temperature is quickly changed, and the medium molecules are gasified by the heat exchanger for forming the pneumatic source.

12. The solar thermodynamic machine power generation method, as recited in claim 4, wherein in step (B), the ceramic molecular sieve isolates the liquid working medium from the energy-storage molten salt, so that a phase of the liquid working medium at low temperature is quickly changed, and the medium molecules are gasified by the heat exchanger for forming the pneumatic source.

13. The solar thermodynamic machine power generation method, as recited in claim 5, wherein in step (B), the ceramic molecular sieve isolates the liquid working medium from the energy-storage molten salt, so that a phase of the liquid working medium at low temperature is quickly changed, and the medium molecules are gasified by the heat exchanger for forming the pneumatic source.

14. The solar thermodynamic machine power generation method, as recited in claim 6, wherein in step (B), the ceramic molecular sieve isolates the liquid working medium from the energy-storage molten salt, so that a phase of the liquid working medium at low temperature is quickly changed, and the medium molecules are gasified by the heat exchanger for forming the pneumatic source.

15. The solar thermodynamic machine power generation method, as recited in claim 7, wherein in step (B), the ceramic molecular sieve isolates the liquid working medium from the energy-storage molten salt, so that a phase of the liquid working medium at low temperature is quickly changed, and the medium molecules are gasified by the heat exchanger for forming the pneumatic source.

16. The solar thermodynamic machine power generation method, as recited in claim 8, wherein in step (B), the ceramic molecular sieve isolates the liquid working medium from the energy-storage molten salt, so that a phase of the liquid working medium at low temperature is quickly changed, and the medium molecules are gasified by the heat exchanger for forming the pneumatic source.

17. The solar thermodynamic machine power generation method, as recited in claim 12, wherein the molten salt layer of the solar heat storage pool is mixed with easily ionized potassium and sodium constituent and rare earth nanomaterials.

18. The solar thermodynamic machine power generation method, as recited in claim 15, wherein the molten salt layer of the solar heat storage pool is mixed with easily ionized potassium and sodium constituent and rare earth nanomaterials.

19. The solar thermodynamic machine power generation method, as recited in claim 16, wherein the molten salt layer of the solar heat storage pool is mixed with easily ionized potassium and sodium constituent and rare earth nanomaterials.

20. A solar thermodynamic machine power generation device comprises a solar light-gathering and thermal storage system, a working medium vacuum heat exchanging system, a working medium cooling backflow system, a gasification compression injection system, an electrostatic high-voltage ionization system, a strong magnetic field system, a parallel capacitance plate electronic collection system, a plasma MHD (ionized medium) expansion driving system, and an external battery variable frequency power system.
